(19) United States
(12) Patent Application Publication
(10) Pub. No.: US 2009/0209353 A1
(43) Pub. Date: Aug. 20, 2009

(54) SEALING BELLOWS OR BELLOWS

(76) Inventors: Olaf Abels, Damme (DE); Arnold Blanke, Damme (DE); Jens Diekhoff, Lemförde (DE); Hermann Heitmann, Stemwede (DE); Josef Holtheide, Neuenkirchen-Vörden (DE); Nedal Idies, Berlin (DE)

Correspondence Address: MCGLEW & TUTTLE, PC, P.O. BOX 9227, SCARBOROUGH STATION, SCARBOROUGH, NY, 10510-9227, US

(21) Appl. No.: 12/438,600

(22) PCT Filed: Aug. 10, 2007
(86) PCT No.: PCT/DE2007/001421

§ 371 Date: Feb. 24, 2009

(30) Foreign Application Priority Data
Aug. 25, 2006 (DE) 10 2006 039 861.1

(51) Int. Cl. F16J 15/52; F16D 3/84

(52) U.S. Cl. 464/106; 277/636

(57) ABSTRACT

A sealing bellows or bellows for sealing two components (1, 2) movable in relation to one another is presented, which has two edge areas (4, 5), which are located at spaced locations from one another, are connected by a jacket (3) and in which a clamping element (6, 7) each is embedded. The jacket (3) has a plurality of internal diameters (d2, d3, d4) of different values and the internal diameter (d1) of one of the edge areas (4, 5) of the sealing bellows or bellows (8) is larger than the largest of the internal diameters (d2, d3, d4) of jacket (3) of the sealing bellows or bellows (8). Such a sealing bellows or bellows can be used especially for a ball and socket joint of a motor vehicle.

### CROSS REFERENCE TO RELATED APPLICATIONS

This application is a United States National Phase application of International Application PCT/DE2007/001421 and claims the benefit of priority under 35 U.S.C. § 119 of German Patent Application DE 10 2006 039 861.0 filed Aug. 25, 2006, the entire contents of which are incorporated herein by reference.

### FIELD OF THE INVENTION

The present invention pertains to a sealing bellows or bellows for sealing two components movable in relation to one another, with two edge areas that are located at spaced locations from one another and are connected by a jacket.

### BACKGROUND OF THE INVENTION

A sealing bellows of this class appears, for example, from DE 1 575 684 A. A sealing bellows for a ball and socket joint of a motor vehicle, which is used to seal two components that are movable in relation to one another, is described in the document. The components movable in relation to one another are a ball pivot and a housing, the ball pivot being mounted pivotably and rotatably in the housing of the ball and socket joint. The sealing bellows used to seal these components movably in relation to one another has two edge areas, which are located at spaced locations from one another and in which a clamping element each is embedded. According to the disclosure content of the document, the clamping element may be embedded completely or only partly. A first of the edge areas present at the sealing bellows is sealingly in contact with the ball pivot, whereas the second edge area of the sealing bellows, which said edge area is located opposite, is connected to the housing of the ball and socket joint. A jacket is located between the edge areas of the sealing bellows.

The freedom of motion of the ball pivot may be limited in such a solution. The design of the jacket surface and of the fold formed in this area presets the value of the deflection angle by which the ball pivot can be pivoted in relation to the housing. If this fold is made too small, one of the edge areas of the sealing bellows may be lifted off from the component to be sealed in case of borderline deflections of the ball pivot. However, this would mean a reduction or elimination of the sealing function and is therefore to be avoided. The available deflection angle of the ball pivot is otherwise limited. In addition, such an embodiment requires a relatively large space for installation depending on the size of the fold.

To make it possible to embody larger deflection angles, it is known that bellows can be equipped with a plurality of folds following each other in the direction of their axial extension in the area of their jacket. Larger deflection angles and hence, on the whole, greater freedom of motion of the components movable in relation to one another can be achieved with such “multifold bellows.” WO 2005/121573 A2 discloses a ball and socket joint, in which the sealing bellows has a plurality of folds in the direction of its axial extension in the area of its jacket. The jacket represents a connection between two edge areas formed at the sealing bellows or bellows in this embodiment as well. However, the edge areas are fixed in this prior-art solution to the respective component by means of a retaining ring, which must be put on the edge area from the outside. These usually very simple retaining rings, which possess elastic properties, have the drawback that their mounting is very complicated. In addition, they often have sharp-edged ends, so that there is a risk of damage to the sealing bellows. Retaining ring fastenings, as they are described in WO 2005/121573 A2, may also be used for the above-described sealing bellows, but they have the said drawbacks here as well.

### SUMMARY OF THE INVENTION

The basic object of the present invention is to provide a sealing bellows or bellows that guarantees the greatest possible freedom of motion of two components movable in relation to one another and has, moreover, a simple design and can be manufactured in a cost-effective manner. Furthermore, the use of such a sealing bellows or bellows shall be indicated.

A sealing bellows or bellows for sealing two components movable in relation to one another with two edge areas that are located at spaced locations from one another and are connected by a jacket and into which a clamping element each is embedded is perfected according to the present invention such that the jacket has a plurality of internal diameters having different values and the internal diameter of one of the edge areas of the sealing bellows or bellows is larger than the largest of the internal diameters of the jacket of the sealing bellows or bellows.

The solution according to the present invention makes available a sealing bellows or bellows, which makes possible a high degree of mobility of the components that are movable in relation to one another and are to be sealed by the sealing bellows or bellows. The very complicated mounting operation for fastening the retaining rings at the edge areas, which was hitherto necessary, is eliminated by the clamping elements embedded in the edge areas. In addition, the risk of damage to the sealing bellows or bellows can thus be avoided.

It was hitherto necessary in sealing bellows or bellows with embedded clamping elements in the edge areas to select such a geometric design that removal from the vulcanizing mold or injection mold necessary for the manufacture is readily possible. The sealing bellows or bellows had a regular cylindrical or conical contour for this purpose. The fold or bulge necessary for the freedom of motion of the components movable relative to one another is formed by a corresponding upsetting of the jacket only at the time of mounting of these sealing bellows or bellows. However, this procedure has the drawback that the formation of the fold is not controllable. Depending on the given material constellation and wall thickness of the jacket, the bulge of the sealing bellows or bellows is formed at any desired point of the jacket thereof.

This is where the present invention begins by the internal diameter of one of the edge areas of the sealing bellows or bellows being larger than the largest of the existing internal diameters of the jacket of the sealing bellows or bellows. It is thus also possible to remove a sealing bellows or bellows that can be manufactured as a multifold bellows from the vulcanizing or injection mold without difficulties and the core present in the sealing bellows or bellows can be removed without leading to damage to the component. Thus, the design of the internal shape of the sealing bellows or bellows according to the present invention makes possible a simple and uncomplicated removal from the vulcanizing or injection mold. Consequently, the manufacturability of a sealing bellows or bellows is also decisively simplified and hence improved with the features according to the present invention.

Corresponding to one embodiment of the present invention, it is, moreover, advantageous if the jacket of the sealing bellows or bellows has at least one internal diameter that is smaller than the internal diameter of the jacket, which latter diameter is adjacent to this, when viewed in the axial extension of the sealing bellows or bellows. The at least one indentation thus formed between two folds in the area of the jacket of the sealing bellows or bellows advantageously makes possible a great freedom of motion of the components that are movable in relation to one another and are sealed by the sealing bellows or bellows. Since the sealing bellows or bellows designed according to the present invention opposes the motion of the components movable in relation to one another with an extremely weak resistance only, these components are easily movable.

To facilitate the mounting of the sealing bellows or bellows according to the solution being presented here on the components movable relative to one another, it is advantageous if the clamping elements have an elasticity. It is proposed for this reason that the clamping elements be lock washers. These lock washers, which possess elastic properties and are embedded in the edge areas of the sealing bellows or bellows, can be pulled over the components in question, which are equipped with a sealing bellows or bellows, and are readily in sealing contact with the corresponding surface.

The stress of material, which is also transmitted to the sealing bellows or bellows due to the motion of the components movable in relation to one another, may cause in the course of the service life of such a component at least one of the edge areas of the sealing bellows or bellows to be displaced along one of the components. However, such a displacement implies the risk of damage and hence leakage. To avoid this, a variant of the present invention provides for at least part of at least one of the clamping elements to protrude from this edge area on the radially inner side of the edge area of the sealing bellows or bellows. Fixation of the edge area of the sealing bellows or bellows at the component can be improved by the protruding part of the clamping element. An undesired motion of the sealing bellows or bellows can thus be avoided.

Moreover, it may be of decisive advantage if at least one of the clamping elements embedded in the edge areas of the sealing bellows or bellows has a claw-like design and is caused to engage the surface of the corresponding component in a nonpositive and/or positive-locking manner after the mounting of the sealing bellows or bellows. Due to its claw-like design, the clamping element in question can dig, for example, into the surface of the corresponding component. This process, taking place once during the mounting of the sealing bellows or bellows, guarantees secure fixation of the edge area or of the edge areas of the sealing bellows or bellows to the corresponding components movable in relation to one another. Both edge areas of the sealing bellows or bellows may, of course, also have such clamping elements of a claw-like design. The decision for or against such a solution depends on the material parameters of the corresponding components. Such a claw-like shape of the clamping elements can be preferably used when the corresponding components are manufactured from a softer material than the clamping elements. However, this is not an obligatory requirement for the implementation of this embodiment. A groove-like recess, with which the components of the clamping elements or of the clamping element having a claw-like design mesh, may also be provided in the corresponding components. Thus, several solutions for securing the edge areas of the sealing bellows or bellows against an undesired motion in the axial direction are within the scope of this inventive idea.

Corresponding to one embodiment of the present invention, it is proposed, furthermore, that the largest internal diameter of one of the edge areas of the sealing bellows or bellows corresponds to the internal diameter of one of the clamping elements. Thus, both the edge area in question and the clamping element embedded in the edge area have the same internal diameter. The internal diameter of the clamping element is defined here as the section of this clamping element located radially farthest on the inside.

As was already explained in the introduction, it is a drawback in the sealing bellows or bellows known hitherto with clamping elements embedded in their edge areas on both sides that the fold or bulge of the jacket is formed only by the mounting of the sealing bellows or bellows and the fold does not have a defined design. It is proposed for this reason that the jacket of the sealing bellows or bellows has alternating sections with increased and reduced cross sections in relation to its axial extension. The essential advantage is that the sections with increased cross section have a higher stability than the sections with reduced cross sections. Consequently, the points of the jacket at which a bulge or indentation will be formed can be exactly predetermined in a sealing bellows or bellows of such a design, because these bulges or indentations develop in the areas that have a reduced cross section. Thus, the sealing bellows or bellows according to the solution being presented here have a uniform outer contour in the mounted state as well. This is advantageous especially because the design of adjacent components can thus be performed very accurately and considerable installation space can be saved.

A continuation of the above-mentioned measures on a sealing bellows or bellows leads to the jacket of the sealing bellows or bellows having a plurality of folds, whose flanks have an increased cross section each.

The sealing bellows or bellows according to the present invention can be advantageously used for a ball and socket joint especially for use in a motor vehicle.

A preferred embodiment of the present invention will be explained in more detail below on the basis of the drawings attached. The exemplary embodiment shown represents no limitation to the variant being shown but is used only to explain a principle of the present invention. Identical or similar components are designated by the same reference numbers. To illustrate the mode of operation according to the present invention, the figures show only greatly simplified schematic views, in which components not essential for the present invention are not shown. However, this does not mean that such components are not present in the solution according to the present invention. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is an axial sectional view through a sealing bellows or bellows according to the present invention;

FIG. 2 is a perspective view component drawing of a clamping element embedded in one of the edge areas of the sealing bellows or bellows;

FIG. 3 is a perspective view component drawing of another clamping element embedded in one of the edge areas of the sealing bellows or bellows;

FIG. 4 is a sectional view through an assembly unit with a sealing bellows or bellows according to the present invention;

FIG. 5a is a view showing one of two stages of the manufacture of a sealing bellows or bellows according to the present invention;

FIG. 5b is a view showing another of two stages of the manufacture of a sealing bellows or bellows according to the present invention; and

FIG. 5c is a view showing the manufactured sealing bellows or bellows according to the present invention.

### DESCRIPTION OF THE PREFERRED EMBODIMENTS

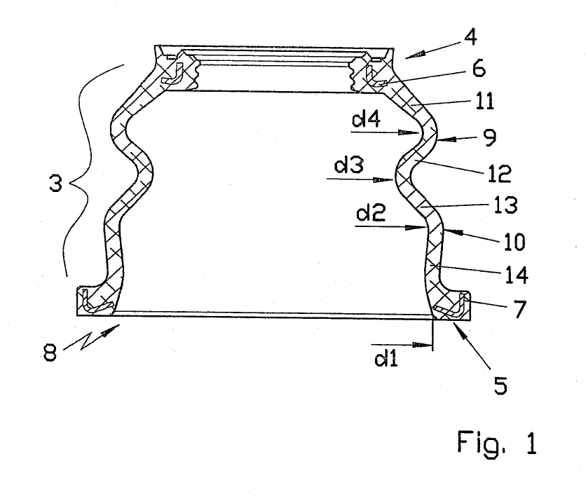

Referring to the drawings in particular, FIG. 1 shows a sealing bellows or bellows, which is designated as a whole by 8 and is shown in an axial cross section. This has two edge areas 4 and 5 arranged at spaced locations from one another. The rotationally symmetrical sealing bellows or bellows 8 has a jacket 3 between the edge areas 4 and 5. The sealing bellows or bellows 8 is characterized, when viewed in its axial extension, by a plurality of consecutive diameters of different values. It is essential here that the internal diameter d1 of edge area 5 is larger than the largest of the other diameters d2, d3 and d4 of jacket 3. The contour of jacket 3 forms, when viewed in the cross section, a wave shape, which means for the sealing bellows or bellows 8 that this has a plurality of folds 9 and 10 following each other in its axial extension. Sections with a larger cross section alternate with sections having a reduced cross section. The sections with a larger cross section form flanks 11, 12, 13 and 14. The areas with a smaller material cross section are located between them. The consequence of this is that after the sealing bellows or bellows shown has been removed from the vulcanizing or injection mold, the characteristic folds of the jacket surface 3 are formed without a special effect being needed for this. A clamping element 6 is vulcanized into edge area 4 of the sealing bellows or bellows 8. The vulcanization process can be used to manufacture such a sealing bellows or bellows, because this is manufactured, as a whole, from an elastic material. This material may be, in particular, rubber, which can be prepared, for example, from natural rubber. An edge area 5 is formed on the sealing bellows or bellows 8 on the opposite side of edge area 4. This edge area 5 receives a clamping element 7, which is likewise embedded directly in this edge area 5 during the vulcanization operation, i.e., during the manufacture of the sealing bellows or bellows 8. The internal diameter d1 of this clamping element 7 corresponds in this case to the internal diameter of edge area 5 and represents the largest of the internal diameters present in the area of the jacket surface 3 of the sealing bellows or bellows 8. Core 19 present in the mold used to manufacture the sealing bellows or bellows 8 can be removed without problems due to this special geometric shape without the sealing bellows or bellows being damaged. The edge area 4 of the sealing bellows or bellows 8 being shown has the peculiarity that a labyrinth seal is formed on its inner jacket surface. This wave-shaped labyrinth seal improves the contact with the component to be sealed.

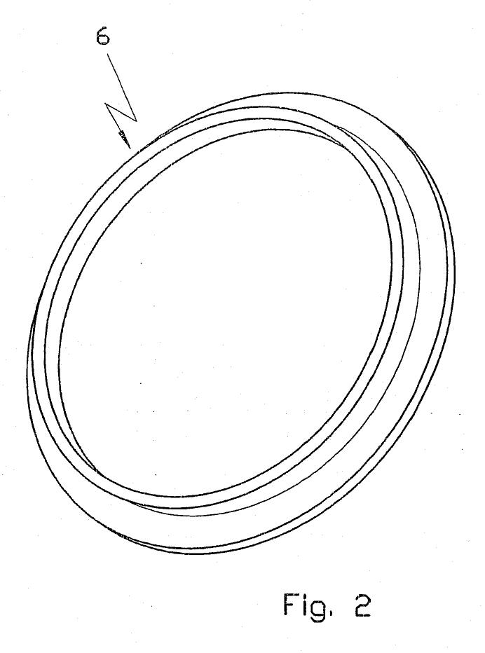

FIG. 2 shows as an example a component drawing of a perspective view of clamping element 6, which is embedded in the edge area 4 of the sealing bellows or bellows 8. The leg of this clamping element 6 having an L-shaped cross section, which said leg extends approximately in parallel to the axial extension of the sealing bellows or bellows 8, has an approximately parallel course in relation to the component sealed by the edge area 4 in the mounted state of the sealing bellows or bellows 8.

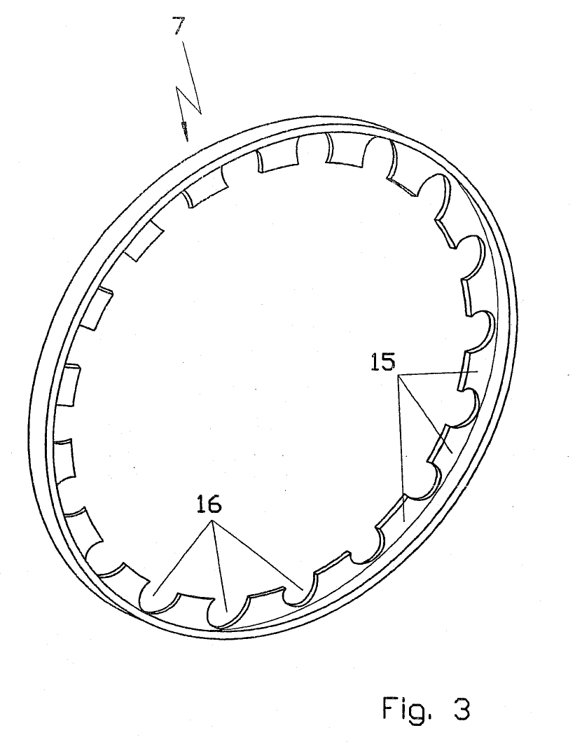

Another embodiment variant of a clamping element for being embedded in one of the edge areas of the sealing bellows or bellows is likewise shown as a component drawing and in a perspective view in FIG. 3. The peculiarity of this clamping element 7, which is preferably embedded in the edge area 5 of the sealing bellows or bellows 8, is that this has numerous recesses 16 distributed over its circumference on the radially inner side of the sealing bellows or bellows 8. Teeth 15 are formed between the recesses 16. These teeth 15 ensure secure fixation of the edge area 5 to the corresponding component. The edge area 5 of the sealing bellows or bellows 8 is thus secured in this manner against axial migration. As is apparent from the view in FIG. 3 and likewise from the sectional view in FIG. 1, the teeth 15 have an angular orientation in relation to the axial longitudinal direction of the sealing bellows or bellows 8. The fixation of the edge area 5 at the component to be sealed is decisively improved by this angle of incidence because an increase in the elasticity of the clamping element 7 can thus be achieved.

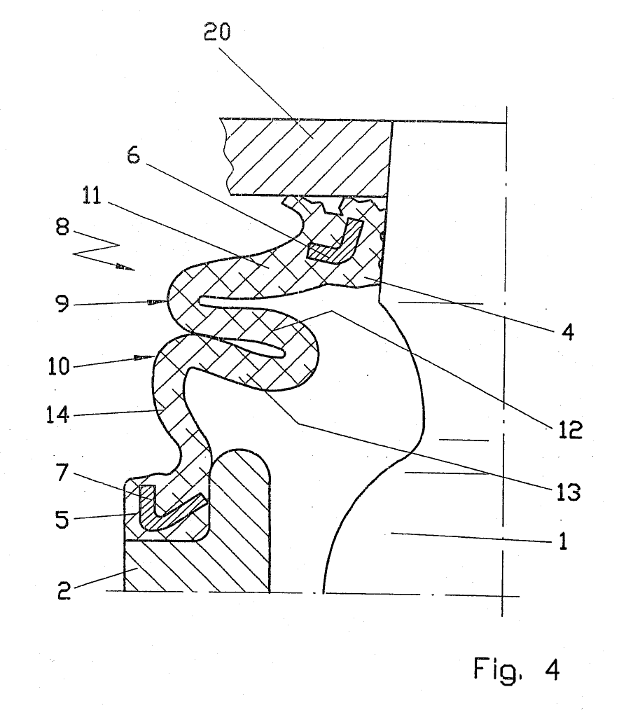

FIG. 4 shows a section through an assembly unit, which has a sealing bellows or bellows 8 according to the present invention. The assembly unit shown comprises a first component 1 and a second component 2. The first component 1 is a ball pivot of a ball and socket joint, whose joint ball is mounted within a housing in a rotatingly movable and pivotable manner. Component 2 represents this housing and can be recognized in FIG. 4 in the form of a suggestion only. The sealing bellows or bellows 8 is arranged between the pin section of the ball pivot 1 and a contact surface formed herefor on housing 2. The sealing bellows or bellows is in contact by its edge area 4 and the clamping element 6 embedded therein with the ball pivot 1. The edge area 5 located opposite with the clamping element 7 embedded therein is in contact with housing 2. The clamping element 7 is elastically supported with one of its flanks against the contact surface of housing 1. Jacket 3 of the sealing bellows or bellows 8 extends between the edge areas 4 and 5. Said sealing bellows or bellows has a plurality of flanks 11, 12, 13 and 14 following one another, which together form two folds 9 and 10 following one another when viewed in the axial extension of the sealing bellows or bellows. The assembly unit shown in FIG. 4 is shown in a non-deflected state of the ball pivot. The folds are arranged in close contact with one another in this state. The labyrinth seal of edge area 4 of the sealing bellows or bellows 8 is formed on two sides of the edge area 4 in the exemplary embodiment being shown here and is supported, as was already mentioned, at the ball pivot 1, on the one hand, and at a fastening component 20 of the motor vehicle, on the other hand.

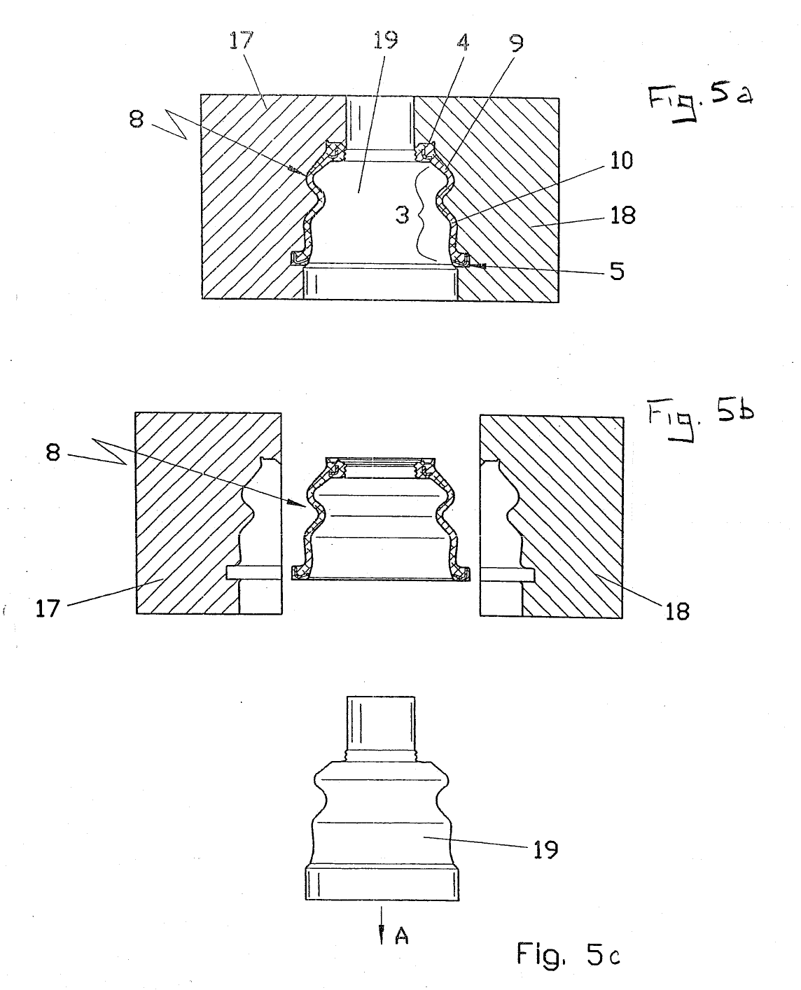

FIG. 5 shows the manufacture of a sealing bellows or bellows according to the present invention on the basis of a simplified stage plan. Part “a” of FIG. 5 shows a closed vulcanizing or injection mold. This comprises a first mold half 17 and a second mold half 18. The partition of the mold extends along the axial central longitudinal axis of the sealing bellows or bellows 8. A core 19 is inserted into the cavity formed within the mold halves 17 and 18, so that a cavity corresponding to the sealing bellows or bellows 8 is left between the core 19 and the inner surfaces of the mold halves 17 and 18. Liquefied elastomer, preferably rubber, is injected into this cavity. To embed the clamping elements 6 and 7 in the edge areas 4 and 5 of the sealing bellows or bellows 8 during the vulcanization operation, these edge areas are inserted into the vulcanizing or injection mold in corresponding positions before the beginning of the vulcanization operation. A shape, which corresponds to the final shape of the sealing bellows or bellows 8, is thus imparted to the sealing bellows or bellows 8 already during the vulcanization operation. To remove the finished and cooled sealing bellows or bellows 8 from the mold, the mold halves 17 and 18 are moved apart at right angles to the axial central longitudinal axis of the sealing bellows or bellows 8. This state of the process is shown in part “b” of FIG. 5 in a schematically simplified manner. Besides the separation of the mold halves 17 and 18 from one another, core 19 is removed from the interior space of the sealing bellows or bellows 8 as well. Core 19 is removed in the direction of arrow A in FIG. 5b. This direction corresponds to the direction of the axial central longitudinal axis of the sealing bellows or bellows 8. Core 19 can also be removed without further difficulties because the internal diameter d1 of edge area 5 as well as of the clamping element 7 embedded therein is larger than the other diameters d2 through d4 of jacket 3 of the sealing bellows or bellows 8.

While specific embodiments of the invention have been shown and described in detail to illustrate the application of the principles of the invention, it will be understood that the invention may be embodied otherwise without departing from such principles.

1. A sealing bellows or bellows for sealing two components movable in relation to one another, the sealing bellows comprising:
two edge areas located at spaced locations from one another
a jacket, said two edge areas being connected by said jacket;
a clamping element embedded in each of said two edge areas,
said jacket having a plurality of internal diameters, each of said internal diameters having different values and an internal diameter of one of said two edge areas of the sealing bellows or bellows is larger than a largest of the internal diameters of said jacket of the sealing bellows or bellows.

2. A sealing bellows or bellows in accordance with claim 1, wherein said jacket has at least one internal diameter, which is smaller than another internal diameter of said jacket, which said another internal diameter is located adjacent to said least one internal diameter when viewed in the axial extension of the sealing bellows or bellows.

3. A sealing bellows or bellows in accordance with claim 1, wherein said clamping elements are lock washers.

4. A sealing bellows or bellows in accordance with claim 1, wherein at least part of at least one of said clamping elements protrudes from an associated said edge area on a radially inner side of said edge area of the sealing bellows or bellows.

5. A sealing bellows or bellows in accordance with claim 1, wherein at least one of the clamping elements embedded in an associated said edge areas of the sealing bellows or bellows has a claw-like design and is caused to mesh with a surface of a corresponding component in a non-positive and/or positive-locking manner after the sealing bellows or bellows has been mounted.

6. A sealing bellows or bellows in accordance with claim 1, wherein the largest internal diameter corresponds to the internal diameter of one of said clamping elements.

7. A sealing bellows or bellows in accordance with claim 1, wherein said jacket has mutually alternating sections with increased and reduced cross sections relative to an axial extension of said jacket.

8. A sealing bellows or bellows in accordance with claim 7, wherein said jacket has a plurality of folds with flanks each having an increased cross section.

9. (canceled)

10. A ball and socket joint comprising:
a first joint component;
a second joint component, said first joint component and said second joint component being movable in relation to one another, and
a sealing bellows comprising two edge areas located at spaced locations from one another, a jacket, a first edge area and a second edge areas connected by said jacket, a first clamping element embedded in said first edge area, a second clamping element embedded in said second edge area, said jacket having a plurality of internal diameters, each of said internal diameters having different values and an internal diameter of one of said first edge area and said second edge area is larger than a largest of the internal diameters of said jacket, said first edge area being connected to said first joint component and said second edge area being connected to said second joint component.

11. A ball and socket joint in accordance with claim 10, wherein said jacket has at least one internal diameter, which is smaller than another internal diameter of said jacket which said another internal diameter is located adjacent to said least one internal diameter when viewed in the axial extension of said sealing bellows.

12. A ball and socket joint in accordance with claim 10, wherein said clamping elements comprise lock washers.

13. A ball and socket joint in accordance with claim 10, wherein at least part of at least one of said clamping elements protrudes from an associated said edge area on a radially inner side of said edge area of said sealing bellows.

14. A ball and socket joint in accordance with claim 10, wherein at least one of said first clamping element and said second clamping element has a claw-like design and engages with a surface of one of said first joint component and said second joint component in a non-positive and/or positive-locking manner after the sealing bellows has been mounted.

15. A ball and socket joint in accordance with claim 10, wherein the largest internal diameter corresponds to the internal diameter of one of said clamping elements.

16. A ball and socket joint in accordance with claim 10, wherein said jacket has mutually alternating sections with increased and reduced cross sections relative to an axial extension of said jacket.

17. A ball and socket joint in accordance with claim 7, wherein said jacket has a plurality of folds with flanks, each of said flanks having an increased cross section.
